(19) United States
(12) Patent Application Publication
(10) Pub. No.: US 2021/0310439 A1
(43) Pub. Date: Oct. 7, 2021

(54) BLOCK RIBS FOR REDUCING LINER DISTORTION

(71) Applicant: Cummins Inc., Columbus, IN (US)

(72) Inventors: Xiling Zhou, Hubei Province (CN); Vijaysai Karuppiah Kumareshan, Columbus, IN (US); John Jerl Purcell, III, Louisa, VA (US); Mathew A. Clark, Darlington (GB)

(21) Appl. No.: 17/351,639

(22) Filed: Jun. 18, 2021

Related U.S. Application Data
(63) Continuation-in-part of application No. PCT/US19/66271, filed on Dec. 13, 2019.
(60) Provisional application No. 62/781,943, filed on Dec. 19, 2018.

(51) Int. Cl. F02F 7/00; F02F 1/00

(52) U.S. Cl. CPC F02F 7/0021; F02F 2001/008; F02F 1/004

(57) ABSTRACT

An engine block includes one or more cylinder bores at least partially surrounded by a cylinder bore wall. The cylinder bore wall includes a liner stop mechanism to support a liner in the cylinder bore. The engine block has an outer cylinder block wall that is exterior to the cylinder bore wall. The outer cylinder block wall includes at least one rib located relative to the liner stop mechanism to reduce rotation and buckling of the liner during operation of the engine.

### CROSS-REFERENCE TO RELATED APPLICATIONS

The present application is a continuation-in-part of International Application No. PCT/US19/66271 filed on Dec. 13, 2019, which claims the benefit of the filing date of U.S. Provisional Application No. 62/781,943 filed on Dec. 19, 2018, each of which is incorporated herein by reference.

### TECHNICAL FIELD

The present application relates generally to cylinder block walls for an internal combustion engine, and more particularly to a feature on the cylinder block walls partially surrounding a cylinder liner.

### BACKGROUND

Internal combustion engines include one or more cylinders wherein each cylinder includes a piston in the cylinder bore. During the combustion cycle, the piston moves in an upstroke direction and a downstroke direction relative to the cylinder bore. Cylinder walls of the cylinder bore can become very worn or damaged from use. If the engine is not equipped with replaceable sleeves, there is a limit to how far the cylinder walls can be bored or worn before the block must be sleeved or replaced.

Cylinder wall thickness is important to efficient thermal conductivity in the engine. When choosing sleeves, engines have specifications to how thick the cylinder walls should be to prevent overworking the coolant system. Each engine's needs are different, depending on designed work load duty cycle and energy produced.

A cylinder liner is a cylindrical part to be fitted into an engine block to form a cylinder. The cylinder liner, serving as the inner wall of a cylinder, forms a sliding surface for the piston rings while retaining the lubricant within. The cylinder liner receives combustion heat through the piston and piston rings and transmits the heat to the coolant. The cylinder liner prevents the compressed gas and combustion gas from escaping outside. The cylinder liner should be designed such that it is hard to transform by high pressure and high temperature in the cylinder bore.

During operation of the piston in the combustion cycle, a liner seat of the cylinder liner can rotate which can cause the liner to buckle under load in the direction of the liner axis. Moreover, the liner can buckle due to loads from cylinder pressure or thermal expansion. If the liner is installed using press-fit or transitional fit techniques which can close under thermal or pressure-related expansion, then the liner may rotate about the cylinder axis or expand which decreases the durability of the liner.

Therefore, further contributions in this area of technology are needed to improve the durability of the cylinder block walls of the engine. Therefore, there remains a significant need for the apparatuses, methods and systems disclosed herein.

### SUMMARY

A system, method, and apparatus that includes an engine block for an internal combustion engine is disclosed. The engine block includes one or more cylinder bores wherein each cylinder bore is surrounded by a cylinder bore wall. The cylinder bore wall includes a liner stop mechanism configured to locate a liner in the cylinder bore. The cylinder bore includes a mid-portion that spans between an upper end and a lower end, wherein the liner stop mechanism can be located near the upper end, near the lower end, or in the mid-portion of the cylinder bore. The engine block has an outer cylinder block wall that is exterior to the cylinder bore wall.

In an embodiment, the outer cylinder block wall includes a first rib positioned above the liner stop mechanism and a second rib positioned below the liner stop mechanism relative to a cylindrical axis of the cylinder bore. The first and second ribs straddle the liner stop mechanism and reduce rotation of the liner seat hence reducing the propensity of the liner to buckle under load in the direction of the cylindrical axis of the cylinder bore, or due to loads from cylinder pressure or thermal expansion. The first and second ribs also act to reduce rotation or expansion of the liner wall where the liner is in contact with the engine block due to press-fit, or transitional fits which tend to close under thermal or pressure related expansion. The reduction or suppression of the liner by the first and second ribs improves the piston ring conformability wherein ring conformability is a function of the distortion of the cylinder bore and piston ring's ability to bend to these distortions. The reduction or suppression of the liner by the first and second ribs also improves the oil consumption of the engine.

In an embodiment, the outer cylinder block wall includes at least one rib with a first end above the liner stop mechanism and a second end below the liner stop mechanism. The width of the rib between the first and second ends spans the liner stop mechanism.

This summary is provided to introduce a selection of concepts that are further described below in the illustrative embodiments. This summary is not intended to identify key or essential features of the claimed subject matter, nor is it intended to be used as an aid in limiting the scope of the claimed subject matter. Further embodiments, forms, objects, features, advantages, aspects, and benefits shall become apparent from the following description and drawings.

### BRIEF DESCRIPTION OF THE DRAWINGS

The concepts described herein are illustrative by way of example and not by way of limitation in the accompanying figures. For simplicity and clarity of illustration, elements illustrated in the figures are not necessarily drawn to scale. Where considered appropriate, references labels have been repeated among the figures to indicate corresponding or analogous elements.

FIG. 1 is a perspective view of an engine assembly of the present disclosure.

FIG. 2 is a cross-sectional view of the engine assembly of FIG. 1 of the present disclosure.

FIG. 3 is a right side view of the engine assembly of FIG. 1 of the present disclosure.

FIG. 4 is a left side view of the engine assembly of FIG. 1 of the present disclosure.

FIG. 5 is another cross-sectional view of the engine assembly of the present disclosure.

FIGS. 6A and 6B are schematic diagrams of the ribs and the cylinder bore.

FIG. 7 is a cross-sectional of another embodiment of the engine assembly of the present disclosure.

### DETAILED DESCRIPTION OF ILLUSTRATIVE EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended, any alterations and further modifications in the illustrated embodiments, and any further applications of the principles of the invention as illustrated therein as would normally occur to one skilled in the art to which the invention relates are contemplated herein.

A cylinder liner is a cylindrical part to be fitted into an engine block to form a cylinder. The cylinder liner, serving as the inner wall of a cylinder, forms a sliding surface for the piston rings while retaining the lubricant within. Some important functions of cylinder liners include an excellent sliding surface as well as high anti-galling properties, less wear on the cylinder liner itself, less wear on the partner piston ring, and less consumption of lubricant.

A cylinder liner or sleeve is installed by boring the cylinder to a size that is larger than normal inserted with an interference fit. Alternatively, the liners can be pressed into place, or they can be held in by a shrink fit. Cylinder wall thickness is important to efficient thermal conductivity in an internal combustion engine. When choosing sleeves, engines have specifications to how thick the cylinder walls should be to prevent overworking the coolant system. Each engine's needs are different, dependent on designed work load duty cycle and energy produced.

The cylinder liner receives combustion heat through the piston and piston rings and transmits the heat to the coolant. The cylinder liner prevents the compressed gas and combustion gas from escaping outside.

There are three types of liners. The engine can have a bore that is a liner in the base block or cylinder material, a dry liner which is a liner assembled into base block or cylinder without direct contact between coolant and liner, or a wet liner which is a liner assembled into base block or cylinder with direct contact between coolant and liner.

Moreover, there are three liner types including top, mid and bottom stop. Generally, the cylinder head sealing surface is called the top end of the engine. The top-stop liner concept includes a flange on the top of the liner with which it is located into the cylinder block. The mid-stop liner has a similar flange at or near the middle of the liner, and the bottom stop liner has its locating flange near the lower end of the liner. In any of the top, mid, and bottom stop liner configurations, the cylinder bore of the engine block includes a liner stop mechanism that is configured to receive the liner.

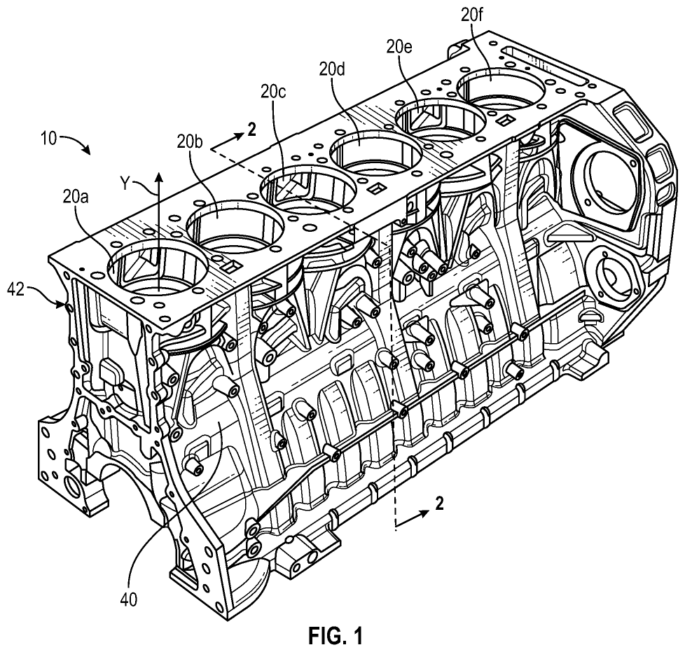

Turning now to FIG. 1, an engine block 10 is shown for an internal combustion engine (not illustrated). The engine is an internal combustion engine of any type, and can include a stoichiometric engine, a gasoline engine, alcohol engine (e.g. ethanol or methanol), or a natural gas engine. In the illustrated embodiment, the engine block 10 includes and at least partially defines six cylinder bores 20a, 20b, 20c, 20d, 20e, and 20f, in an in-line arrangement. However, the number of cylinders may be any number, and the arrangement of cylinders may be any arrangement, and is not limited to the number and arrangement shown in FIG. 1.

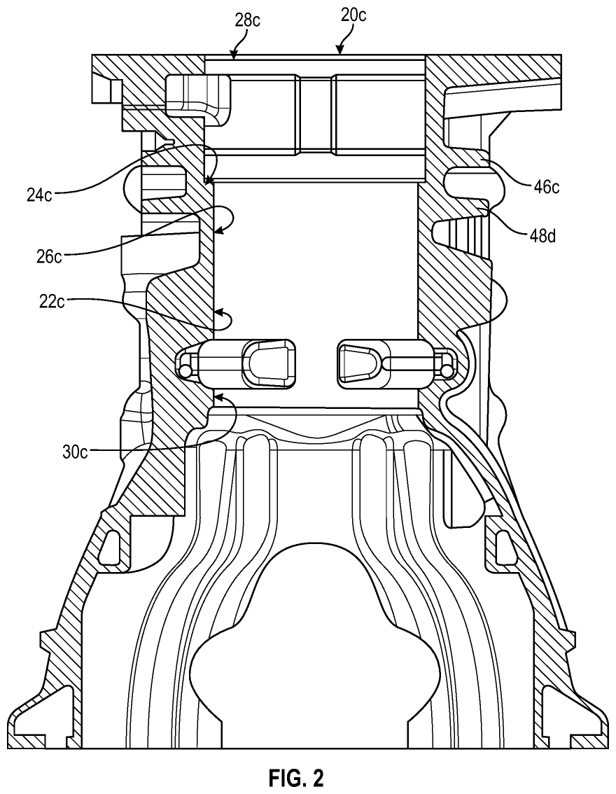

Each of the cylinder bores 20a-20f is surrounded by a cylinder bore wall, shown by cylinder bore wall 22c of cylinder 20c in FIG. 2, it being understood that cylinders 20a-20b and 20d-20f can include a cylinder bore wall like cylinder bore wall 22c of cylinder 20c. Each of the cylinder bore walls of cylinders 20a-20f also includes a liner stop mechanism, such as shown with liner stop mechanism 24c of cylinder 20c, configured to locate a liner or sleeve (not illustrated) in the cylinder bores 20a-20f. The liner stop mechanism 24c in the illustrated embodiment is a lip, ledge, flange, rim, projecting edge, ridge or other configuration in the cylinder bore wall 22c. In other embodiments, the liner stop mechanism 24c can be configured differently to engage and retain the liner in the cylinder bore 20c. The cylinder bore wall 22c includes a mid-portion 26c that spans between an upper end 28c and a lower end 30c. A cylindrical axis Y (FIG. 1) spans between the upper and lower ends 28c and 30c. In the illustrated embodiment in FIG. 2, the liner stop mechanism 24c is located in the mid-portion 26c of the cylinder bore wall 22c. In other embodiments, the liner stop mechanism 24c is located at or near either the upper end 28c or the lower end 30c of the cylinder bore wall 22c. The other cylinders 20a-20b, and 20d-20f may have liner stop mechanisms similarly positioned as described for liners stop mechanism 24c.

Each of the cylinder bores 20a-20f is configured to receive a cylinder liner (not illustrated) to define a combustion chamber. A piston (not shown) may be slidably disposed within each of the liners in the cylinder bores 20a-20f to reciprocate between a top-dead-center position and a bottom-dead-center position, and a cylinder head (not shown) may be associated with each of the cylinder bores 20a-20f. Each of the cylinder bores 20a-20f, its respective piston, and the cylinder head form a combustion chamber. In the illustrated embodiment, engine block 10 includes six such combustion chambers. However, it is contemplated that engine block 10 may include a greater or lesser number of cylinders and combustion chambers and that the cylinders and combustion chambers may be disposed in an “in-line” configuration, a “V” configuration, or in any other suitable configuration.

Cylinder liners may be inserted into cylinder bores 20a-20f under a variety of conditions. One such condition is a press fit, also known as an interference fit or friction fit, for example, creates an axial hold where adjoining parts share the same space by creating a slight elastic deformation and a compression force between the adjoining parts. Compression from the press fit increases the friction between the adjoining parts to a point where independent movement of the adjoining parts is not possible under normal operating conditions. Press fits between the cylinder liner and engine block 10 may be created using physical presses, principles of thermal expansion or other suitable method.

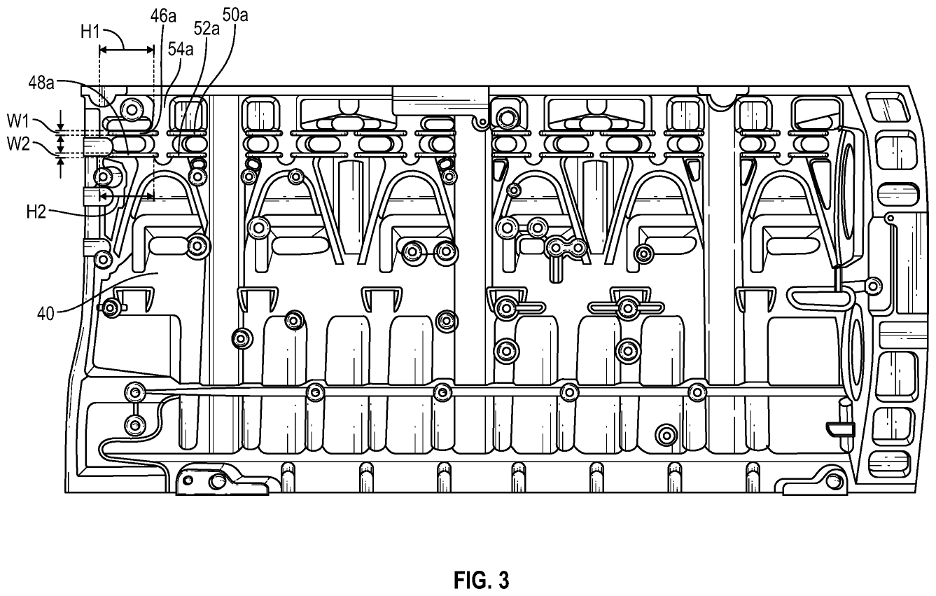

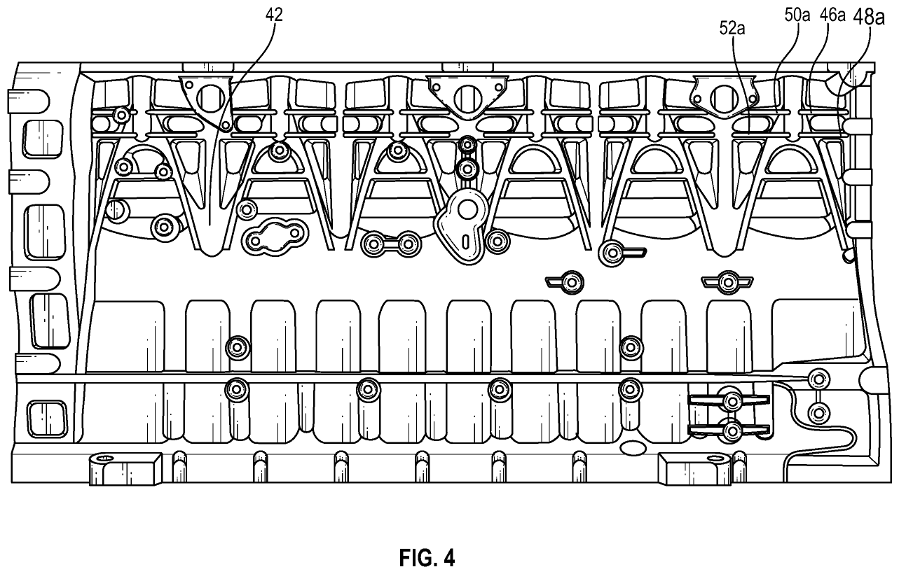

As illustrated in FIGS. 3 and 4, the engine block 10 includes a first outer cylinder block wall 40 opposite a second outer cylinder block wall 42 with the cylinders bores 20a-20f between the first and second outer cylindrical block walls 40 and 42. Each of the first and second outer cylinder block walls 40 and 42 surround at least a portion of the cylinder bore walls of the cylinders bores 20a-20f. The first outer cylinder block wall 40 includes a first rib 46a positioned above the liner stop mechanism 24a of cylinder bore 20a and a second rib 48a positioned below the liner stop mechanism 24a of cylinder bore 20a relative to the cylindrical axis Y of the cylinder bore 20a. In the illustrated embodiment, the first outer cylinder block wall 40 also includes a third rib 50a positioned above the liner stop mechanism 24a and a fourth rib 52a positioned below the liner stop mechanism 24a relative to the cylindrical axis Y of the cylinder bore 20a. A head boss 54a is positioned between the first and third ribs 46a and 50a and the second and fourth ribs 48a and 52a.

In other forms, the first and third ribs 46a and 50a may be one monolithic rib without the presence of the head boss 54a. Similarly, the second and fourth ribs 48a and 52a may be one monolithic rib without the presence of the head boss 54a. As such, the first and third ribs 46a and 50a form a single rib that is located above the liner stop mechanism 24a. Similarly, the second and fourth ribs 48a and 52a form a single rib that is located below the liner stop mechanism 24a. In yet other forms, the first and third ribs 46a and 50a may be a single rib and the second and fourth ribs 48a and 52a may be separate ribs, or vice versa. The second outer cylinder block wall 42 also includes similar first and second ribs as described with respect to the first outer cylinder block wall 40 therefore for the sake of brevity these will not be described again.

The first outer cylindrical block wall 40 includes additional first and second ribs similar to first and second ribs 46a and 48a for each of the remaining cylinder bores 20b-20f. The first outer cylindrical block wall 40 includes additional third and fourth ribs similar to third and fourth ribs 50a and 52a for each of the remaining cylinder bores 20b-20f. The additional first, second, third and fourth ribs will not be described for the sake of brevity.

The first, second, third, and fourth ribs 46a, 48a, 50a, and 52a generally follow the circumference of cylinder bore 20a or the liner that would be installed therein. The first rib 46a is placed above the liner stop mechanism 24a and the second rib 48a is positioned below the liner stop mechanism 24a, with a space there between in the direction of the cylindrical axis Y. The first and second ribs 46a and 48a act to reduce rotation of a liner seat of a liner installed in the cylinder bore 20a and reduce the propensity of the liner to buckle under loads in the direction of a liner axis, or due to loads from cylinder pressure or thermal expansion. The first and second ribs 46a and 48a also act to reduce rotation or expansion of a liner wall of the liner, where the liner is in contact with the engine block 10 due to press-fit, or transitional fits which typically close under thermal or pressure related expansion.

In one form, the first rib 46a and the third rib 50a are positioned closer to the liner stop mechanism 24a than the second rib 48a and the fourth rib 52a as measured relative to the cylindrical axis Y. In another form, the second rib 48a and fourth rib 52a are positioned closer to the liner stop mechanism 24a than the first rib 46a and the third rib 50a as measured relative to the cylindrical axis Y. In yet another embodiment, the first, second, third, and fourth ribs 46a, 48a, 50a, and 52a are positioned equidistant from the liner stop mechanism 24a as measured relative to the cylindrical axis Y.

The first rib 46a has a first width W1 and the second rib 48a has a second width W2 wherein the first rib 46a and the second rib 48a extend in a direction of the cylindrical axis Y of the cylinder bore 20a. In one form, the first width W1 and the second width W2 are the same, in other forms they are different. The first rib 46a has a first height H1 and the second rib 48a has a second height H2 such that the first and the second ribs 46a and 48a extend in a direction perpendicular to the cylindrical axis Y of the cylinder bore 20a. The third rib 50a is similar to the first rib 46a, and the fourth rib 52a is similar to the second rib 48a.

The unique configuration of the first, second, third, and fourth ribs 46a, 48a, 50a, and 52a of the first outer cylinder block wall 40 and the corresponding ribs on the second outer cylinder block wall 42 that surround or partially surround the wet cylinder liner in the cylinder bore 20a beneficially reduce deformation or distortion of the wet cylinder liner under installation and operating conditions. The first, second, third, and fourth ribs 46a, 48a, 50a, and 52a of the first outer cylinder block wall 40 and the corresponding ribs on the second outer cylinder block wall 42 also reduce engine oil consumption and can apply on top, mid or bottom stop liner configurations. Moreover the first, second, third, and fourth ribs 46a, 48a, 50a, and 52a do not add too much weight or cost to manufacture. The first, second, third, and fourth ribs 46a, 48a, 50a, and 52a are also easy to manufacture for gray iron block casting.

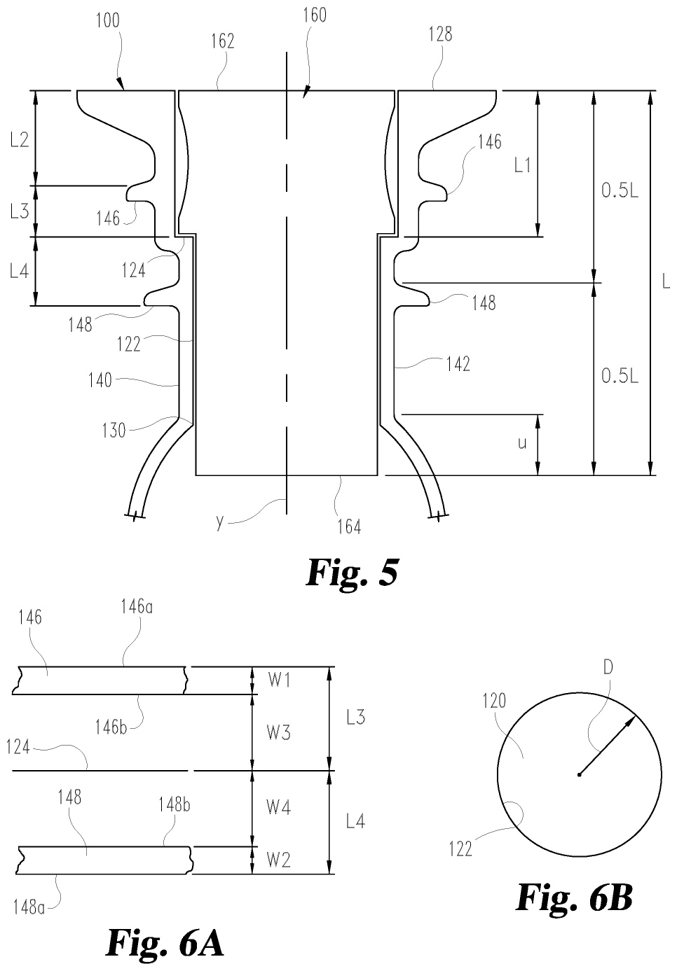

Referring to FIG. 5, another block having supports for a cylinder liner stop mechanism is shown. Engine block 100 can be similar to block 10 discussed above, and includes at least one cylinder bore 120 with a cylinder bore wall 122 having a liner stop mechanism 124. A cylinder liner 160 is shown in cylinder bore 120 that is supported on liner stop mechanism 124. Cylinder bore 120 extends from an upper end 128 at the top of, or at the cylinder head sealing surface of, block 100 and into the block 100 to a lower end 130 of the cylinder bore wall 122.

Cylinder liner 160 extends from an upper liner end 162 located at upper end 128 of the cylinder bore wall 122 to a lower liner end 164 located below lower end 130 of bore 120. In FIG. 5, the distance between upper and lower ends 162, 164 along cylinder axis Y is designated by length L. The mid-point M of the length L of cylinder liner 140 is shown located at a distance of 0.5 L below upper end 128. The lower part of cylinder liner 160 may include an unsupported length U that projects below lower end 130. In an embodiment, the unsupported length U is no more than 25% of the overall length L of cylinder liner 160.

Liner stop mechanism 124 is located above the mid-point of the cylinder liner in the illustrated embodiment. The location of liner stop mechanism 124 is a distance L1 from upper end 128 of cylinder bore wall 122. Distance L1 is less than 0.5 L and above the mid-point M. In an embodiment, distance L1 is less than 50% of length L and more than 10% of length L. In an embodiment, distance L1 is less than 40% of length L and more than 10% of length L. In an embodiment, distance L1 is less than 30% of length L and more than 10% of length L. In an embodiment, the distance L1 is such that the liner stop mechanism 124 is positioned above the location of the maximum side thrust of the piston so that thrust force is directed to the location of liner stop mechanism 124.

The engine block 100 includes a first outer cylinder block wall 140 that is opposite a second outer cylinder block wall 142 with the cylinder bore(s) 120 between the first and second outer cylindrical block walls 140 and 142. Each of the first and second outer cylinder block walls 140 and 142 surround at least a portion of the cylinder bore walls of the cylinders bore(s) 120. The first outer cylinder block wall 140 includes at least one rib 146 positioned above the liner stop mechanism 124 of cylinder bore 120 and at least one rib 148 positioned below the liner stop mechanism 124 of cylinder bore 120. As discussed above, it is contemplated that rib 146 and/or rib 148 may include multiple ribs that are positioned about the cylinder bore 120. In addition, a head boss or other structure on wall 140, 142 may interrupt one or more of the ribs 146, 148.

As also shown in FIG. 6A, rib 146 has an upper side 146a positioned a distance L3 above liner stop mechanism 124. Upper side 146a is also located a distance L2 below upper end 128. An area of reduced wall thickness is provided along distance L2 to upper side 146a. Rib 148 has a lower side 148a positioned a distance L4 below liner stop mechanism 125. The rib 146 has a width W1 from upper side 146a to a lower side 146b thereof. The rib 148 has a width W2 from lower side 148a to an upper side 148b thereof. The lower side 146b of rib 146 is spaced from liner stop mechanism 124 by a distance W3, and the lower side 148a of rib 148 is spaced from liner stop mechanism 124 by a distance W4. Areas of reduced wall thickness, as compared to the outwardly projecting thickness of ribs 146, 148, are provided along distances W3 and W4 of walls 140, 142. An area of reduced wall thickness is also provided below rib 148.

In an embodiment, distance W3 and W4 vary between upper and lower limits. In an embodiment, W3 and W4 can vary from 5 millimeters to 20 millimeters. In an embodiment, W3 and W4 are not the same distance but both are between the upper and lower limits. In an embodiment, W3 and W4 are the same distance and are between the upper and lower limits. In an embodiment, W3 and W4 are selected or determined as a function of a cylinder bore diameter D of cylinder bore 120. For example, the cylinder bore 120 includes a diameter D (FIG. 6B) defined by cylinder bore wall 122. The distance W3 and/or W4 can be selected as a function of the bore diameter D. For example, the distance W3 and/or W4 can increase parametrically from their minimum distance as the bore diameter D increases. Widths W1 and/or W2 of ribs 146 and/or 148, however, can remain constant regardless of the bore diameter D. In an embodiment, widths W1 and W2 are selected so that distances W3 and/or W4 are maintained between their upper and lower limits, and distance L2 is at least five millimeters.

In an embodiment, distance W1+W3 and distance W2+W4 vary between upper and lower limits. In an embodiment, W1+W3 and W2+W4 can vary from more than 5 millimeters to 20 millimeters. In an embodiment, W1+W3 and W2+W4 are not the same distance but both are between the upper and lower limits. In an embodiment, W1+W3 and W2+W4 are selected as a function of a cylinder bore diameter D of cylinder bore 120, and/or can increase parametrically as a cylinder bore diameter D increases.

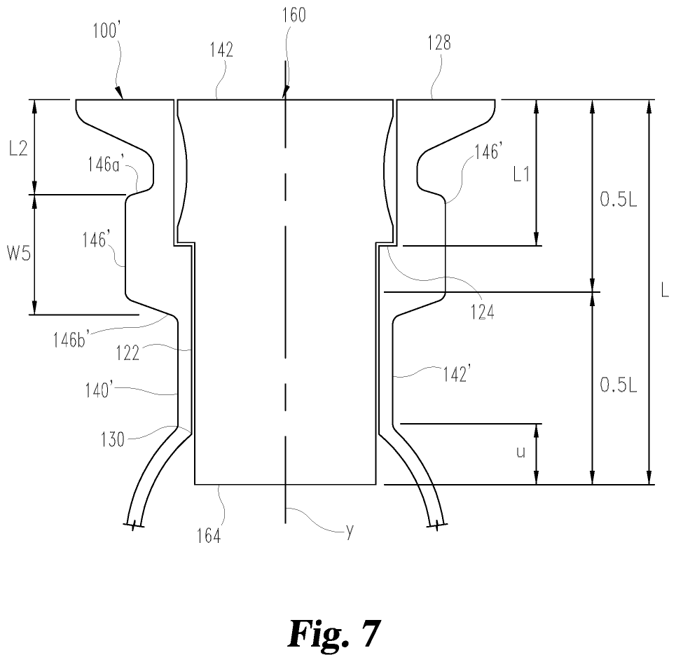

Referring to FIG. 7, another embodiment engine block 100′ is shown that is similar to engine block 100, except that each of the cylinder block walls 140′, 142′ includes a single rib 146′. Each rib 146′ spans the liner stop mechanism 124 along the respective wall 140′, 142′, and extends from an upper side 146a′ to a lower side 146b′ thereof. Each rib 146′ includes a width W5 from the upper side 146a′ to the lower side 146b′. Walls 140′, 142′ have a reduced thickness compared to ribs 146′ in the regions above and below ribs 146′.

The width W5 is selected so that upper side 146a′ is a minimum distance above liner stop mechanism 124, and lower side 146b′ is a minimum distance below liner stop mechanism 124. The minimum distance above and below liner stop mechanism 124 can be, for example, 5 millimeters in one embodiment, so that the overall width W5 is at least 10 millimeters. However, upper side 146a′ and lower side 146b′ can be located at different distances above and below liner stop mechanism 124 so long as a minimum distance is maintained. The width W5 can also be selected as a function of the bore diameter D. For example, width W5 can increase parametrically from the minimum width W5 as the bore diameter D increases.

As is evident from the figures and text presented above, a variety of aspects of the present disclosure are contemplated. According to one aspect, an apparatus comprising an engine block for an internal combustion engine, the engine block having a cylinder bore surrounded by a cylinder bore wall, the cylinder bore wall including a liner stop mechanism configured to locate a liner in the cylinder bore, the engine block having an outer cylinder block wall that surrounds at least a portion of the cylinder bore wall, the outer cylinder block wall including a first rib positioned above the liner stop mechanism and a second rib positioned below the liner stop mechanism relative to a cylindrical axis of the cylinder bore.

In one embodiment, the first rib is positioned closer to the liner stop mechanism than the second rib. In one embodiment, the second rib is positioned closer to the liner stop mechanism than the first rib. In one embodiment, the first rib and the second rib are positioned equidistant from the liner stop mechanism.

In one embodiment, the first rib has a first width and the second rib has a second width, the first and the second ribs extend in a direction of the cylindrical axis of the cylinder bore. In a refinement of this embodiment, the first width and the second width are the same.

In one embodiment, the first rib has a first height and the second rib has a second height, the first and the second ribs extend in a direction perpendicular to the cylindrical axis of the cylinder bore. In one embodiment, the outer cylinder block wall includes a first outer cylinder block wall and a second outer cylinder block wall, and each of the first and the second outer cylinder block walls includes the first and second ribs. In one embodiment, the cylinder bore includes a mid-portion that spans between an upper end and a lower end, the liner stop mechanism being located near the upper end of the cylinder bore.

In one embodiment, the cylinder bore includes a mid-portion that spans between an upper end and a lower end, the liner stop mechanism being located in the mid-portion of the cylinder bore. In one embodiment, the cylinder bore includes a mid-portion that spans between an upper end and a lower end, the liner stop mechanism being located near the lower end of the cylinder bore. In one embodiment, further comprises a liner assembled in the cylinder bore.

According to another aspect, an apparatus comprising an engine block for an internal combustion engine, the engine block having at least one cylinder bore surrounded by a cylinder bore wall, the cylinder bore wall including a liner stop mechanism configured to locate a liner in the cylinder bore, the engine block having an outer cylinder block wall with a first rib and a second rib arranged to straddle the liner stop mechanism exteriorly of the cylinder bore wall.

In one embodiment, the first rib is positioned closer to the liner stop mechanism than the second rib. In one embodiment, the second rib is positioned closer to the liner stop mechanism than the first rib. In one embodiment, the first rib and the second rib are positioned equidistant from the liner stop mechanism.

In one embodiment, the first rib has a first width and the second rib has a second width, the first and the second ribs extend in a direction of the cylindrical axis of the cylinder bore. In one embodiment, the first rib has a first height and the second rib has a second height, the first and the second ribs extend in a direction perpendicular to the cylindrical axis of the cylinder bore. In one embodiment, the at least one cylinder bore includes a plurality of cylinder bores arranged in line, each of the cylinder bores having a set of the first and second ribs wherein a first set of the first and second ribs extend towards an adjacent set of the first and second ribs.

In one embodiment, the outer cylinder block wall includes a first outer cylinder block wall and a second outer cylinder block wall, and each of the first and the second outer cylinder block walls includes the first and second ribs. In one embodiment, the cylinder bore includes a mid-portion that spans between an upper end and a lower end, the liner stop mechanism being located near the upper end of the cylinder bore. In one embodiment, the cylinder bore includes a mid-portion that spans between an upper end and a lower end, the liner stop mechanism being located in the mid-portion of the cylinder bore.

In one embodiment, the cylinder bore includes a mid-portion that spans between an upper end and a lower end, the liner stop mechanism being located near the lower end of the cylinder bore. In one embodiment, further comprises a liner assembled in the cylinder bore. In one embodiment, the first rib includes two ribs and the second rib includes two ribs.

In the above description, certain relative terms may be used such as “up,” “down,” “upper,” “lower,” “horizontal,” “vertical,” “left,” “right,” “proximal,” “distal,” and the like. These terms are used, where applicable, to provide some clarity of description when dealing with relative relationships. But, these terms are not intended to imply absolute relationships, positions, and/or orientations. For example, with respect to an object, an “upper” surface can become a “lower” surface simply by turning the object over. Nevertheless, it is still the same object.

Reference throughout this specification to “one embodiment,” “an embodiment,” or similar language means that a particular feature, structure, or characteristic described in connection with the embodiment is included in at least one embodiment of the present disclosure. Appearances of the phrases “in one embodiment,” “in an embodiment,” and similar language throughout this specification may, but do not necessarily, all refer to the same embodiment. Similarly, the use of the term “implementation” means an implementation having a particular feature, structure, or characteristic described in connection with one or more embodiments of the present disclosure, however, absent an express correlation to indicate otherwise, an implementation may be associated with one or more embodiments.

The described features, structures, advantages, and/or characteristics of the subject matter of the present disclosure may be combined in any suitable manner in one or more embodiments and/or implementations. In the following description, numerous specific details are provided to impart a thorough understanding of embodiments of the subject matter of the present disclosure. One skilled in the relevant art will recognize that the subject matter of the present disclosure may be practiced without one or more of the specific features, details, components, materials, and/or methods of a particular embodiment or implementation. In some instances, the benefit of simplicity may provide operational and economic benefits and exclusion of certain elements described herein is contemplated as within the scope of the invention herein by the inventors to achieve such benefits. In other instances, additional features and advantages may be recognized in certain embodiments and/or implementations that may not be present in all embodiments or implementations. Further, in some instances, well-known structures, materials, or operations are not shown or described in detail to avoid obscuring aspects of the subject matter of the present disclosure. The features and advantages of the subject matter of the present disclosure will become more fully apparent from the following description and appended claims, or may be learned by the practice of the subject matter as set forth hereinafter.

The present subject matter may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus, comprising:
an engine block including a cylinder bore wall defining a cylinder bore that extends from an upper end of the engine block to a lower end of the cylinder bore within the engine block, the cylinder bore wall including a liner stop mechanism that supports a liner in the cylinder bore at a location along a length of the liner, the engine block having an outer cylinder block wall along at least a portion of the cylinder bore wall, the outer cylinder block wall including at least one rib projecting outwardly from the cylinder block wall that includes an upper surface positioned a first distance above the liner stop mechanism and an opposite lower surface positioned a second distance below the liner stop mechanism, wherein the upper surface is also positioned a third distance below the upper end of the engine block and the lower surface is located above the lower end of the cylinder bore.

2. The apparatus of claim 1, wherein at least one of the first and second distances varies as a function of a diameter of the cylinder bore.

3. The apparatus of claim 2, wherein the at least one of the first and second distances increases parametrically as the diameter of the cylinder bore increases.

4. The apparatus of claim 1, wherein the at least one rib includes a first rib positioned above the liner stop mechanism and a second rib positioned below the liner stop mechanism, the first rib including the upper surface and the second rib including the lower surface.

5. The apparatus of claim 4, wherein the first rib includes a second lower surface opposite the upper surface and the second rib includes a second upper surface opposite the lower surface, wherein the second lower surface of the first rib is spaced a minimum distance above the liner stop mechanism and the lower surface of the second rib is spaced a minimum distance below the liner stop mechanism.

6. The apparatus of claim 5, wherein the minimum distance is 5 millimeters.

7. The apparatus of claim 5, wherein the second lower surface of the first rib is spaced a maximum distance above the liner stop mechanism and the lower surface of the second rib is spaced a maximum distance below the liner stop mechanism.

8. The apparatus of claim 7, wherein the maximum distance is 20 millimeters.

9. The apparatus of claim 1, wherein the length of the liner extends from an upper end of the liner located at the upper end of the engine block to a lower end of the liner located below the lower end of the cylinder bore such that the liner includes an unsupported length extending below the lower end of the cylinder bore, and the location of the liner stop mechanism is above a mid-point of the length of the liner.

10. The apparatus of claim 10, wherein the unsupported length is 25% of the length of the cylinder liner.

11. The apparatus of claim 1, wherein the at least one rib is a single rib that spans the liner stop mechanism and extends from the upper surface to the lower surface.

12. The apparatus of claim 1, wherein the outer cylinder block wall includes a first wall on one side of the cylinder bore and a second wall on an opposite side of the cylinder bore, and further comprising at least one rib on each of the first and second walls.

13. An apparatus, comprising:
an engine block including a cylinder bore wall defining a cylinder bore that extends from an upper end of the engine block to a lower end of the cylinder bore within the engine block, the cylinder bore wall including a liner stop mechanism that supports a liner in the cylinder bore at a location along a length of the liner, the engine block having an outer cylinder block wall along at least a portion of the cylinder bore wall, the outer cylinder block wall including a first rib projecting outwardly from the cylinder block wall that is located a first distance above the liner stop mechanism and a second rib positioned a second distance below the liner stop mechanism, wherein the first rib is also positioned a third distance below the upper end of the engine block and the second rib is positioned above the lower end of the cylinder bore.

14. The apparatus of claim 13, wherein the first, second, and third distances are each at least 5 millimeters.

15. The apparatus of claim 13, wherein the first and second distances are different.

16. The apparatus of claim 13, wherein at least one of the first and second distances varies as a function of a diameter of the cylinder bore.

17. The apparatus of claim 16, wherein the at least one of the first and second distances increases parametrically as the diameter of the cylinder bore increases.

18. An apparatus, comprising:
an engine block including a cylinder bore wall defining a cylinder bore that extends from an upper end of the engine block to a lower end of the cylinder bore within the engine block, the cylinder bore wall including a liner stop mechanism that supports a liner in the cylinder bore at a location along a length of the liner, the engine block having an outer cylinder block wall forming a first wall and a second wall along opposite sides of the cylinder bore wall, each of the first and second walls including a single rib projecting outwardly therefrom that spans the liner stop mechanism, each of the ribs forming an upper surface positioned a first minimum distance above the liner stop mechanism and an opposite lower surface positioned a second minimum distance below the liner stop mechanism, wherein the upper surface is also positioned a third distance below the upper end of the engine block and the lower surface is positioned above the lower end of the cylinder bore.

19. The apparatus of claim 18, wherein at least one of the first and second minimum distances increases as a diameter of the cylinder bore increases.

20. The apparatus of claim 18, wherein the first and second minimum distances are at least 5 millimeters.
